(19) United States
(12) Patent Application Publication
(10) Pub. No.: US 2010/0107248 A1
(43) Pub. Date: Apr. 29, 2010

(54) REAL-TIME DATA PROTECTION METHOD AND DATA PROTECTION DEVICE FOR IMPLEMENTING THE SAME

(76) Inventor: Hung-Chien Chou, Taichung City (TW)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/603,538

(22) Filed: Oct. 21, 2009

(30) Foreign Application Priority Data
Oct. 23, 2008 (TW) 097140657

(51) Int. Cl. G06F 21/00; G06F 12/14

(52) U.S. Cl. 726/22; 726/26

(57) ABSTRACT

A real-time data protection method includes: receiving input data from an input device; storing the input data; sending the input data to a computing device, thereby permitting the computing device to generate result data based on the input data; receiving the result data from the computing device; generating test data that correspond to the result data; comparing the test data to the input data; and when it is determined that the test data are not identical to the input data, indicating that the result data have been modified. A data protection device that implements the real-time data protection method is also disclosed.

### CROSS-REFERENCE TO RELATED APPLICATION

This application claims priority of Taiwanese application no. 097140657, filed on Oct. 23, 2008.

### BACKGROUND OF THE INVENTION

1. Field of the Invention

This invention relates to a data protection method, particularly to a real-time data protection method.

2. Description of the Related Art

As the information industry progresses, computers and the Internet, through which computer information are accessed, have become indispensable communication tools in our daily lives. This results in proliferation of hackers who intentionally and maliciously intrude into a computer system and alter or destroy data or programs in the computer system. This poses a major threat to the reliability of computer information. Various techniques have been proposed to counter that threat.

One conventional technique utilizes a computer firewall. Unfortunately, computer firewalls have security loopholes that may be exploited by a hacker to get through the computer firewall and gain access to information in a computer.

In another conventional technique, input data are manually inspected to determine whether the input data have been modified. This conventional technique, however, is time consuming.

In yet another conventional technique, a program calculates a hash value for each packet of input data using a hash function and stores the input data in a storage device. A different hash value calculated at a later time indicates whether or not the corresponding packet of the input data has been modified. The modified input data may be recovered using an original copy of the input data previously stored in the storage device. This conventional technique is disadvantageous in that a large capacity storage device is required. In addition, the program is vulnerable to viruses and hackers.

### SUMMARY OF THE INVENTION

Therefore, an object of the present invention is to provide a real-time data protection method that can overcome the aforesaid drawbacks of the prior art.

Another object of the present invention is to provide a data protection device that implements the real-time data protection method.

According to an aspect of the present invention, a real-time data protection method is implemented by a data protection device, and comprises: A) configuring the data protection device to receive input data from an input device; B) configuring the data protection device to store the input data received in step A); C) configuring the data protection device to send the input data stored in step B) to a computing device, the computing device generating result data based on the input data sent thereto by the data protection device; D) configuring the data protection device to receive the result data from the computing device; E) configuring the data protection device to generate test data that correspond to the result data received in step D); F) configuring the data protection device to compare the test data generated in step E) to the input data stored in step B); and G) when it is determined in step F) that the test data are not identical to the input data, configuring the data protection device to indicate that the result data have been modified.

According to another aspect of the present invention, a data protection device comprises a comparing unit and a test data-generating unit. The comparing unit is adapted to be coupled to an input device and a computing device, and is configured to receive input data from the input device, to store the input data received thereby, and to send the input data to the computing device. The computing device generates result data based on the input data sent thereto by the comparing unit. The test data-generating unit is coupled to the comparing unit, is adapted to be coupled to the computing device, and is configured to receive the result data from the computing device, to generate test data that correspond to the result data received thereby, and to send the test data generated thereby to the comparing unit. The comparing unit is further configured to receive the test data sent thereto by the test data-generating unit, to compare the test data received thereby to the input data stored thereby, and to indicate that the result data have been modified when it is determined thereby that the test data are not identical to the input data.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit block diagram of the preferred embodiment of a data protection device according to the present invention; and

FIGS. 2 and 3 are flow charts of the preferred embodiment of a real-time data protection method according to the present invention to be implemented using the data protection device shown in FIG. 1.

### DETAILED DESCRIPTION OF THE PREFERRED EMBODIMENT

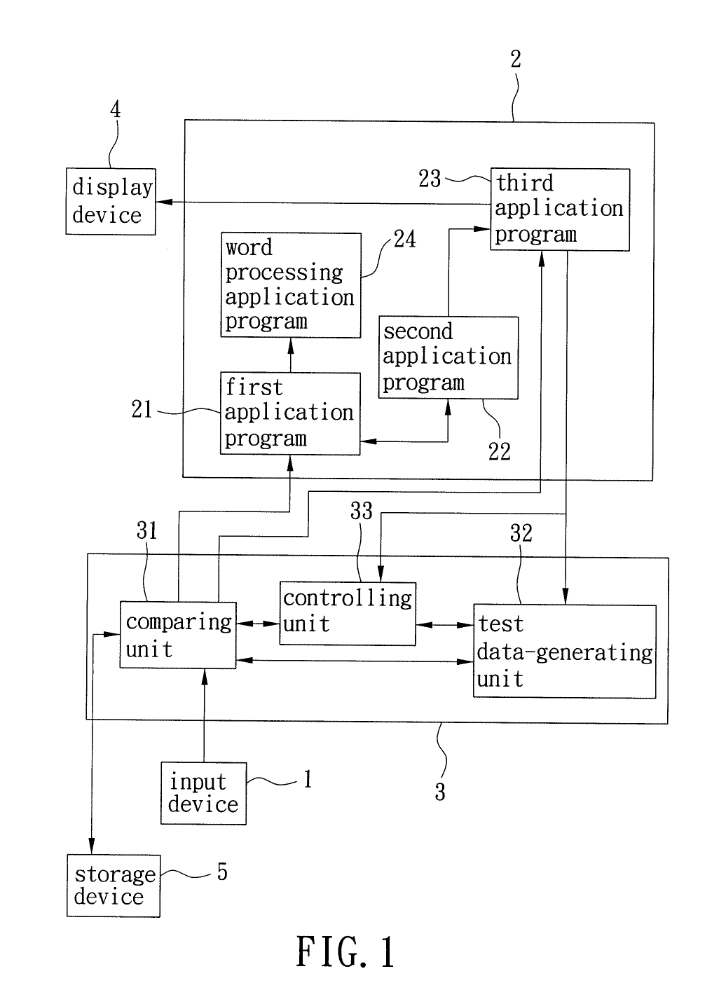

Referring to FIG. 1, the preferred embodiment of a data protection device 3 according to this invention is shown to include a comparing unit 31 and a test data-generating unit 32.

The comparing unit 31 is connected to an input device 1, a computing device 2, and a storage device 5.

The input device 1 may be a computer keyboard, a computer mouse, or a touch panel.

The computing device 2 is installed with an operating system, and a word processing application program 24, e.g., Microsoft Word, which resides in the operating system, and is connected to a display device 4.

The storage device 5 stores therein first, second, and third executable files, each of which has an attribute that is set to hidden.

The test data-generating unit 32 is connected to the comparing unit 31 and the computing device 2.

The data protection device 3 further includes a controlling unit 33 connected to and controlling operations of the comparing unit 31 and the test data-generating unit 32.

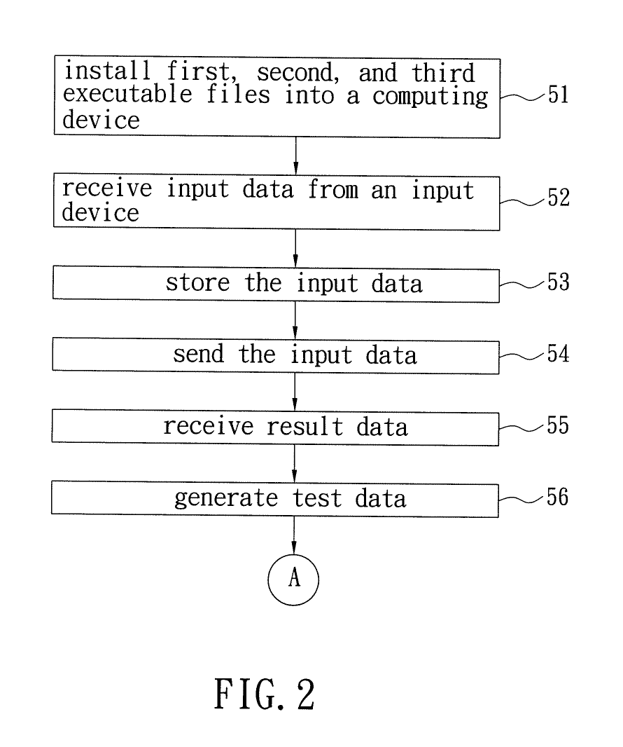

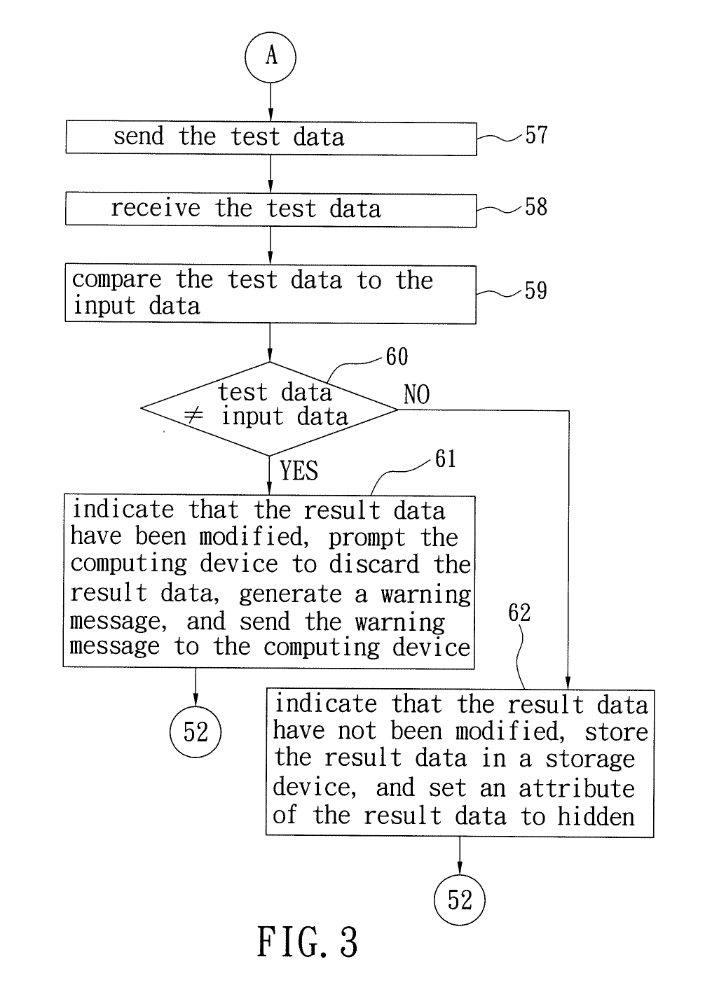

The preferred embodiment of a real-time data protection method to be implemented by the aforementioned data protection device 3 according to this invention will now be described with further reference to FIGS. 2 and 3.

In step 51, the comparing unit 31 sets the attributes of the first, second, and third executable files stored in the storage device 5 to read-only, and subsequently installs the first, second, and third executable files into the computing device 2, whereby the first, second, and third executable files serve as first, second, and third application programs 21, 22, 23 that reside in the operating system, respectively.

In step 52, the comparing unit 31 receives input data from the input device 1.

In step 53, the comparing unit 31 stores therein the input data received in step 52.

Alternatively, in this step, the input data may be stored in the storage device 5.

In step 54, the comparing unit 31 sends the input data stored in step 53 to the first application program 21.

The first application program 21 receives the input data sent thereto by the comparing unit 31, generates result data based on the input data received thereby, and sends the result data to the word processing application program 24.

The second application program 22 detects the result data generated by the first application program 21, and sends the result data detected thereby to the third application program 23.

The third application program 23 receives the result data sent thereto by the second application program 22, and sends the result data received thereby to the test data-generating unit 32.

In step 55, the test data-generating unit 32 receives the result data sent thereto by the third application program 23.

In step 56, the test data-generating unit 32 generates test data that correspond to the result data received in step 55.

For example, suppose that the first application program 21 is a Chinese input method editor (IME). Suppose further that the input data received in step 52 are in the form of pinyin. The result data generated by the first application program 21 are thus associated with Chinese characters and the test data generated in this step are thus in the form of pinyin.

In step 57, the test data-generating unit 32 sends the test data generated in step 56 to the comparing unit 31.

In step 58, the comparing unit 31 receives the test data sent thereto in step 57.

In step 59, the comparing unit 31 compares the test data received in step 58 to the input data stored in step 53.

In step 60, when it is determined in step 59 that the test data are not identical to the input data, the flow proceeds to step 61. Otherwise, i.e., it is determined in step 59 that the test data are identical to the input data, the flow proceeds to step 62.

In step 61, the comparing unit 31 indicates that the result data have been modified, prompts the third application program 23 to discard the result data, generates a warning message, and sends the warning message to the third application program 23. Thereafter, the flow goes back to step 52.

The third application program 23 controls the display device 4 to show the warning message sent to the third application program 23 by the comparing unit 31.

In step 62, the comparing unit 31 indicates that the result data have not been modified, stores the result data received in step 55 in the storage device 5, and sets an attribute of the result data stored thereby to hidden. Thereafter, the flow goes back to step 52.

The result data stored in this step can be used for data recovery when required in the future.

From the above description, since the comparing unit 31 stores an original copy of the input data, based on which the computing device 2 generates the result data, since the test data-generating unit 32 generates the test data that correspond to the result data, and since the comparing unit 31 compares the test data to the original copy of the input data stored thereby, the data protection device 3 of this invention determines in real-time whether the result data have been modified.

Furthermore, since the attributes of the first, second, and third executable files are set to read-only prior to installation thereof in the computing device 2 by the comparing unit 31, the first, second, and third executable files are prevented from being modified.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A real-time data protection method to be implemented by a data protection device coupled to an input device and a computing device, said real-time data protection method comprising:
A) configuring the data protection device to receive input data from the input device;
B) configuring the data protection device to store the input data received in step A);
C) configuring the data protection device to send the input data stored in step B) to the computing device, the computing device generating result data based on the input data sent thereto by the data protection device;
D) configuring the data protection device to receive the result data from the computing device;
E) configuring the data protection device to generate test data that correspond to the result data received in step D);
F) configuring the data protection device to compare the test data generated in step E) to the input data stored in step B); and
G) when it is determined in step F) that the test data are not identical to the input data, configuring the data protection device to indicate that the result data have been modified.

2. The real-time data protection method as claimed in claim 1, further comprising:
H) when it is determined in step F) that the test data are identical to the input data, configuring the data protection device to indicate that the result data have not been modified.

3. The real-time data protection method as claimed in claim 2, the data protect ion device being further coupled to a storage device, wherein step H) includes the sub-steps of:
h1) configuring the data protection device to store the result data received in step D) in the storage device; and
h2) configuring the data protection device to set an attribute of the result data stored in sub-step h1) to hidden.

4. The real-time data protection method as claimed in claim 1, the data protection device being further coupled to a storage device, wherein, in step B), the input data is stored in one of the data protection device and the storage device.

5. The real-time data protection method as claimed in claim 1, the computing device being coupled to a display device, wherein step G) includes the sub-steps of:
g1) configuring the data protection device to prompt the computing device to discard the result data;
g2) configuring the data protection device to generate a warning message; and
g3) configuring the data protection device to send the warning message generated in sub-step g2) to the computing device, the computing device controlling the display device to show the warning message sent thereto by the data protection device.

6. The real-time data protection method as claimed in claim 1, the data protection device being further coupled to a storage device, said real-time data protection method further comprising:
I) configuring the data protection device to set an attribute of an executable file stored in the storage device to read-only; and
J) configuring the data protection device to install the executable file into the computing device, thereby permitting the computing device to generate the result data.

7. The real-time data protection method as claimed in claim 1, the data protection device being further coupled to a storage device, said real-time data protection method further comprising:
I) configuring the data protection device to set an attribute of an executable file stored in the storage device to read-only; and
J) configuring the data protection device to install the executable file into the computing device, thereby permitting the computing device to send the result data generated thereby to the data protection device.

8. The real-time data protection method as claimed in claim 1, the result data generated by the computing device being associated with Chinese characters, wherein the test data generated in step E) are in the form of pinyin.

9. A data protection device, comprising:
a comparing unit adapted to be coupled to an input device and a computing device, and configured to receive input data from the input device, to store the input data received thereby, and to send the input data to the computing device, the computing device generating result data based on the input data sent thereto by said comparing unit; and
a test data-generating unit coupled to said comparing unit, adapted to be coupled to the computing device, and configured to receive the result data from the computing device, to generate test data that correspond to the result data received thereby, and to send the test data generated thereby to said comparing unit;
wherein said comparing unit is further configured to receive the test data sent thereto by said test data-generating unit, to compare the test data received thereby to the input data stored thereby, and to indicate that the result data have been modified when it is determined thereby that the test data are not identical to the input data.

10. The data protection device as claimed in claim 9, wherein said comparing unit is further configured to store the result data received by said test data-generating unit from the computing device when it is determined thereby that the test data are identical to the input data.

11. The data protection device as claimed in claim 9, wherein said comparing unit is further configured to generate a warning message, and to send the warning message generated thereby to the computing device when it is determined thereby that the test data are not identical to the input data, the computing device controlling a display device to show the warning message sent to the computing device by said comparing unit.

12. The data protection device as claimed in claim 9, wherein said comparing unit is further configured to prompt the computing device to discard the result data when it is determined thereby that the test data are not identical to the input data.

13. The data protection device as claimed in claim 9, the result data generated by the computing device being associated with Chinese characters, wherein the test data generated by said test data-generating unit are in the form of pinyin.
